(19) United States
(12) Patent Application Publication
(10) Pub. No.: US 2003/0215089 A1
(43) Pub. Date: Nov. 20, 2003

(54) Method and apparatus for encrypting and decrypting messages based on boolean matrices

(76) Inventors: Miodrag Mihaljevic, Tokyo (JP); Ryuji Kohno, Tokyo (JP)

Correspondence Address: FROMMER LAWRENCE & HAUG LLP, 745 FIFTH AVENUE, NEW YORK, NY, 10151, US

(21) Appl. No.: 10/411,348

(22) Filed: Apr. 10, 2003

(30) Foreign Application Priority Data
Apr. 11, 2002 (JP) 2002-109513

(51) Int. Cl. H04L 9/00

(52) U.S. Cl. 380/42

(57) ABSTRACT

This invention provides a method and an apparatus for executing improved Boolean matrices based encryption and decryption. In a data communication system, a server generates a series of encrypted data message blocks C₁, C₂, . . , Cₘ from plain data blocks P₁, P₂, . . . , Pₘ, by computing Cᵢ=K(Pᵢ+K*ᵢVT)Kᵢ. A client receives the encrypted data and generates a series of plain data message blocks P₁, P₂, . . . , Pₙ; by computing Pᵢ=K⁻¹CᵢK*ᵢ+K*ᵢVT.

### DETAILED DESCRIPTION OF THE INVENTION

1. Field of the Invention

The present invention relates to cryptographic techniques for processing secure data communications, and in particular to a method and an apparatus for encrypting and decrypting data based on Boolean matrices.

2. Description of the Related Art

A software re-configurable radio system or software defined radio (SDR) is based on downloading of all the relevant software via a public channel, and accordingly the security issue of the downloading is one of the key issues.

One of the most pressing issues for the commercial introduction of software defined radio (SDR) systems is the authentication and verification of integrity of the software that is downloaded. Currently, any wireless device or system is required to obtain approval that it conforms to the regulations regarding frequency band, power output, modulation method and so on from appropriate governmental authorities before being manufactured and sold as a commercial device.

However for a SDR terminal, since re-programmable hardware is used, if the software is illegally modified from when it was submitted to the authorities, or indeed has never been approved. Then the use of that software may cause the wireless device to emit radiation illegally, which may cause interference to other users or even physical harm to the user of the wireless device.

Therefore, there must be a method of ensuring that the software downloaded is intact and has not been modified (verification of integrity) and that it has obtained government approval (authentication). Most likely it will also be preferable for the government to know how many of which types of software are presently being distributed.

Furthermore, in the event that some illegally modified software is created, there should be some mechanism to prevent the spread of that illegal software.

The current commercial state of the art for downloading of programs to mobile wireless terminals includes the download to mobile terminals in the form of relatively small programs.

The majority of these programs are entertainment oriented. The feature of these programs is that they do not interfere with the actual physical parameters of the radio wave emitting device.

A software defined radio terminal does intend to modify the physical radio parameters of the device and therefore the issues involved are much more serious.

The size of the file will be much larger, for example the bit file size for a field programmable gate array (FPGA) of one million gates is approximately 766 k-bytes. The complexity and therefore the knowledge which goes into each file will be much larger than current software and therefore worth more to protect this intellectual property.

As a further necessity for the introduction of a software downloadable SDR system, the software should be protected against theft by people or companies who would like to know the details of the software employed by a rival company.

The security issue in software downloading as well as in data transactions includes the following four areas:

Privacy: No one can see the transferred content—implies employment of encryption techniques.

Integrity/Authenticity: No one can tamper with the content transfer—implies employment of the cryptographic techniques for message integrity/authenticity control.

Authentication: Both parties in a transaction are really who they say they are—implies employment of techniques for the entities authentication which include a simple password techniques and more sophisticated cryptographic techniques.

Non-repudiation: A user or provider can not deny theirs actions—implies employment digital signature schemes and appropriate protocols.

FIG. 1 shows a table summarizing the comparison data for showing main differences between a SDR secure downloading and a usual Internet downloading.

The table contains fields of (1) main security requests, (2) Involved parties, (3) required cryptographic techniques, (4) dedicated security requests.

As Shown in the table, SDR downloading is required the higher security procedures than the usual internet downloading.

As described above, Software download is a key operation for software defined radio (SDR). The process of software download enables the introduction of new functionality (defined in software) into the terminal, with the aim of modifying its configuration and/or content.

Downloading of all the relevant software is performed via a public channel, and accordingly the security issue of the downloading is one of the key issues.

The security issue includes a request for employment of the encryption techniques, as well.

Recently a fast encryption technique for multimedia, FEA-M, has been proposed in “X. Yi, C. H. Tan, C. K. Siew and M. R. Syed, “Fast encryption for multimedia”, IEEE Transactions on Consumer Electronics, vol. 47, pp. 101-107, February 2001”. It is based on an interesting approach for employment of the Boolean matrices.

A very undesirable characteristics of FEA-M recently discussed in the following articles.

“M. J. Mihaljevic and R. Kohno, “Cryptographic Evaluation of a Fast Encryption for Multimedia”, SONY Research Forum—SRF2001, Tokyo, Japan, December 2001, Proceedings, 6 pages, in print”.

“M. J. Mihaljevic and R. Kohno, “On wireless communications privacy and security evaluation of encryption techniques”, IEEE Wireless Comm. And Networking Conf.—WCNC2002, Orlando, Fla., USA, March 2002, Proceedings, 4 pages, in print”

The above articles disclose that its effective secret key size is much smaller than the nominal one, and that it is inappropriate for use in the networks with packet loss errors.

### SUMMARY OF THE INVENTION

Accordingly, we propose a novel algorithm for fast encryption which employs some of the approaches used in FEA-M. The algorithm according to this invention has much higher level of cryptographic security, and it is robust against packet loss errors, which is very important for the streaming applications.

Starting from an analysis and comparison of the main security issues related to SDR and an usual Internet downloading, and identified specific characteristics, a novel dedicated cipher for SDR secure downloading based on Boolean Matrices is proposed.

The proposed encryption algorithm does not follow the standard paradigm of a block or stream cipher, it employs a very long secret key, and it is resistant against all known attacks.

Further, the developed encryption technique offers low implementation complexity, and suitability for FPGA and DSP frameworks of SDR.

It is one objective of the present invention to provide a novel enciphering algorithm based on Boolean matrices. It is another objective of the present invention to provide a method for encrypting and decrypting data message utilizing the novel enciphering algorithm based on Boolean matrices. Further, It is another objective of the present invention to provide a data communication system which transmits encrypted data utilizing the novel enciphering algorithm based on Boolean matrices.

According to one aspect of the present invention, a method for encrypting a data message, comprising the steps of:

(A) dividing a data message into a series of blocks P₁, P₂, . . . , Pₘ, wherein block number is m;

(B) calculating: Kⁿ and K⁻ⁿ=(K⁻¹)ⁿ; and, setting: K₀=Kⁿ and K₀*=K⁻ⁿ

wherein the parameters are defined as follows;

K: Session key in form of an n×n binary matrix

K⁻¹: Inverse matrix of K,

(C) for each i=1, 2, . . . , m, do the following steps,

(C-1) calculating: T=[tᵣₛ]=KKᵢ₋₁,

(C-2) calculating:

$$y = {⊕}_{r = 1}^{n} {t}_{rr}$$

(c-3) and calculating Kᵢ and K*ᵢ according to the following equations:

(a) if y=1→Kᵢ=T

(b) if y=0→Kᵢ=KT

(c) if y=1→K*ᵢ=K⁻¹K*ᵢ₋₁

(d) if y=0→K*ᵢ=K⁻¹K⁻¹K*ᵢ₋₁

(D) generating a series of encrypted data message blocks C₁, C₂, . . . , Cₘ; by computing the following equation,

Cᵢ=K(Pᵢ+K*ᵢVT)Kᵢ,

Wherin V is initial n×n binary matrix.

According to another aspect of the present invention, the method further comprising the step of:

generating following values K^{(e)} and V^{(e)} which can be used at the data decryption side for recovering values: K⁻¹ and V,

K^{(e)}=K_{M}K⁻¹K_{M}

V^{(e)}=K_{M}VK_{M}.

According to another aspect of the present invention, a method for decrypting an encrypted data message, comprising the steps of:

(A) inputting a series of encrypted data message blocks C₁, C₂, . . . , Cₘ, wherein block number is m;

(B) calculating: Kⁿ and K⁻ⁿ=(K⁻¹)ⁿ; and, setting: K₀=Kⁿ and K₀*=K⁻ⁿ,

wherein the parameters are defined as follows;

K: Session key in form of an n×n binary matrix

K⁻¹: Inverse matrix of K

(C) for each i=1, 2, . . . , m, do the following steps,

(C-1) calculating: T=[tᵣₛ]=KKᵢ₋₁,

(C-2) calculating:

$$y = {⊕}_{r = 1}^{n} {t}_{rr}$$

(C-3) and calculating Kᵢ and K*ᵢ according to the following equations:

(a) if y=1→Kᵢ=T

(b) if y=0→Kᵢ=KT

(c) if y=1→K*ᵢ=K⁻¹K*ᵢ₋₁

(d) if y=0→K*ᵢ=K⁻¹K⁻¹K*ᵢ₋₁

(D) generating a series of plain data message blocks P₁, P₂, . . . , Pₘ; by computing the following equation,

Pᵢ=K⁻¹CᵢK*ᵢ+K*ᵢVT,

Wherin V is initial n×n binary matrix.

According to another aspect of the present invention, the method further comprising the step of:

generating following values K⁻¹ and V by computing the following equation,

K⁻¹=K_{M}⁻¹K^{(e)}K_{M}⁻¹;

V=K_{M}⁻¹V^{(e)}K_{M}⁻¹.

wherein K_{M} is a master secret key in form of n×n binary matrix, and as to K^{(e)} and V^{(e)}, following equations are defined,

K^{(e)}=K_{M}K⁻¹K_{M}

V^{(e)}=K_{M}VK_{M}.

According to another aspect of the present invention, A data processing device for encrypting a data message, comprising:

(A) a data processing logic for dividing a data message into a series of blocks P₁, P₂, . . . , Pₘ, wherein block number is m;

(B) a data computing logic for calculating Kⁿ and K⁻ⁿ=(K⁻¹)ⁿ; and setting: K₀=Kⁿ and K₀*=K⁻ⁿ

wherein the parameters are defined as follows;

K: Session key in form of an n×n binary matrix

K⁻¹: Inverse matrix of K,

(C) a data computing logic for processing the following calculation (c-1) to (c-3) for each i=1, 2, . . . , m, do,

(C-1) calculation: T=[tᵣₛ]=KKᵢ₋₁,

(C-2) calculation:

$$y = {⊕}_{r = 1}^{n} {t}_{rr}$$

and (c-3) calculation:

(a) if y=1→Kᵢ=T

(b) if y=0→Kᵢ=KT

(c) if y=1→K*ᵢ=K⁻¹K*ᵢ₋₁

(d) if y=0→K*ᵢ=K⁻¹K⁻¹K*ᵢ₋₁

(D) a data computing logic for generating a series of encrypted data message blocks C₁, C₂, . . . , Cₘ; by computing the following equation,

Cᵢ=K(Pᵢ+K*ᵢVT)Kᵢ,

Wherin V is initial n×n binary matrix.

According to another aspect of the present invention, the data processing device further comprises:

a data computing logic for generating following values K^{(e)} and V^{(e)} which are used at the data dexryption side for recovering values: K⁻¹ and V,

K^{(e)}=K_{M}K⁻¹K_{M}

V^{(e)}=K_{M}VK_{M}.

According to another aspect of the present invention, the data processing device is configured in a field programmable gate array.

According to another aspect of the present invention, An data processing device for decrypting an encrypted data message, comprising:

(A) a data input means for inputting a series of encrypted data message blocks C₁, C₂, . . . , Cₘ, wherein block number is m;

(B) a data computing logic for calculating Kⁿ and K⁻ⁿ=(K⁻¹)ⁿ; and, setting: K₀=Kⁿ and K₀*=K⁻ⁿ,

wherein the parameters are defined as follows;

K: Session key in form of an n×n binary matrix

K⁻¹: Inverse matrix of K

(C) a data computing logic for processing the following calculation (c-1) to (c-3) for each i=1, 2, . . . , m, do,

(C-1) calculation: T=[tᵣₛ]=KKᵢ₋₁,

(C-2) calculation:

$$y = {⊕}_{r = 1}^{n} {t}_{rr}$$

and (c-3) calculation:

(a) if y=1→Kᵢ=T

(b) if y=0→Kᵢ=KT

(c) if y=1→K*ᵢ=K⁻¹K*ᵢ₋₁

(d) if y=0→K*ᵢ=K⁻¹K⁻¹K*ᵢ₋₁

(D) a data computing logic for generating a series of plain data message blocks P₁, P₂, . . . , Pₘ; by computing the following equation,

Pᵢ=K⁻¹CᵢK*ᵢ+K*ᵢVT,

Wherin V is initial n×n binary matrix.

According to another aspect of the present invention, the data processing device further comprises:

a data computing logic for generating following values K⁻¹ and V by computing the following equation,

K⁻¹=K_{M}⁻¹K^{(e)}K_{M}⁻¹;

V=K_{M}⁻¹V^{(e)}K_{M}⁻¹.

wherein K_{M} is a master secret key in form of n×n binary matrix, and as to K^{(e)} and V^{(e)}, following equations are defined,

K^{(e)}=K_{M}K⁻¹K_{M}

V^{(e)}=K_{M}VK_{M}.

According to another aspect of the present invention, the data processing device is configured in a field programmable gate array.

### DESCRIPTION OF THE PREFERRED EMBODIMENTS

As explained above, a software re-configurable radio system or software defined radio (SDR) is based on downloading of all the relevant software via a public channel, and accordingly the security issue of the downloading is one of the key issues.

Specific security requests for SDR can be summarized as follows.

(1) Restrictions on Downloading

Only approved software should be possible to download into SDR. Such a request does not exist in an usual secure downloading.

(2) Involved Parties in a Secure Downloading System

A mandatory involved party in a secure downloading system for SDR should be the software approval authority. An usual secure downloading does not require involvement of an approval authority.

(3) User Inaccessibility to the Security System for Downloading

One of the most interesting differences between a system for SDR secure downloading and a system for an usual secure downloading via Internet is that in the SDR case an user should not have any control over the security system. Otherwise, a malicious user could perform illegal actions based on a possibility to control the security system. Particularly, a SDR user should not has any influence on selection of the involved cryptographic techniques and keys. Accordingly, appropriate measures should be included to prevent any access of the user to the security system. A method for enforcing this rule is employment of the tamper resistant hardware.

The specific implementation requests can be summarized as follow:

Both main components for SDR implementation, FPGA and DSP imply that desirable cryptographic components should employ as simple as possible operations over GF(2) for the cryptographic processing.

FEA-M is a recently proposed fast encryption algorithm for multimedia, which is based on Boolean matrices. FEA-M and the algorithm according to this invention, both are packet oriented techniques and based on employment of Boolean matrices but, the proposed algorithm has the following two advantages over FEA-M:

(i) the effective secret key size is equal to the nominal one;

(ii) it is robust against the network errors which cause packet loss.

Analysis of specific security and implementation issues related to secure software downloading implies the following statements relevant for construction of a dedicated encryption technique:

(1) secret key can be very long because an user does not need even to know it;

(2) FPGA as well as DSP implementation suggest dominant employment of simple arithmetic operations like additions and multiplications over GF(2) in order to obtain an efficient implementation.

Some recent research results related to a construction and analysis of a ciphering scheme based on Boolean matrices imply that Boolean matrices approach can be a suitable one for software defined radio.

(1) Boolean Matrices

We consider Boolean matrices, i.e. matrices over the finite field GF(2)={0, 1} in which addition and multiplication are defined as follows:

$$\begin{matrix}0 ⊕ 0 = 0 , & 0 \cdot 0 = 0 \\ 0 ⊕ 1 = 1 , & 0 \cdot 1 = 0 \\ 1 ⊕ 0 = 1 , & 1 \cdot 0 = 0 \\ 1 ⊕ 1 = 0 , & 1 \cdot 1 = 1 \\ ⊕ : addition , & \\ \cdot : multiplication & \end{matrix}$$

and where the following distributive property holds

(a\mathring{+}b)·c=(a·c)\mathring{+}(b·c)

a·(b\mathring{+}c)=(a·b)\mathring{+}(a·c)

for any a, b, c ∈ GF(2).

On basis of the above definitions, Boolean matrix addition and Boolean matrix multiplication are defined as follows:

For any Boolean matrices

A=[aᵢⱼ]_{n×n}, B=[bᵢⱼ]_{n×n} and C=[cᵢⱼ]_{n×n},

$$A + B = [ {a}_{ij} ] + [ {b}_{ij} ] = [ {a}_{ij} ⊕ {b}_{ij} ]$$

$$AC = [ {a}_{ij} ] [ {c}_{ij} ] = [ {⊕}_{1 \leq k \leq n} {a}_{ik} \cdot {c}_{kj} ]$$

$$where \\ {⊕}_{1 \leq k \leq n} {a}_{ik} \cdot {c}_{kj} = ( {a}_{i1} \cdot {c}_{1 j} ) ⊕ ( {a}_{i2} \cdot {c}_{2 j} ) ⊕ … ⊕ ( {a}_{in} \cdot {c}_{nj} )$$

Note that usually, AC≠CA.

An n×n Boolean matrix A is invertible (or nonsingular) if there exists an n×n Boolean matrix B such that

A·B=B·A=I

where I is the identity n×n binary matrix which has all ones on the main diagonal and its all other elements are equal to zero. If A is an invertible matrix, then its inverse is unique. We denote the inverse of A by A⁻¹.

(2) FEA-M

This section gives an overview of FEA-M as it is proposed in “X. Yi, C. H. Tan, C. K. Siew and M. R. Syed, “Fast encryption for multimedia”, IEEE Transactions on Consumer Electronics, vol. 47, pp. 101-107, February 2001” restricted only to characteristics of FEA-M relevant for our further analysis. FEA-M performs encryption and decryption according to the following.

FIG. 2 shows the FEA-M encryption algorithm. At first, the plain-text message should be divided into a series of blocks P₁, P₂, . . . , Pᵣ with same length n². If the length of the last block is less than n², we need append some 0s in it so that it length is right n². The n² bits of each block are arranged as a square matrix of order n. The encryption and decryption processes involve the session key K and the initial matrix V₀ which are binary matrices of order n. Generation and distribution of these two matrices will be discussed later on, and in this moment we assume that they are known by the sender and receiver, and that they are unknown to any other third party.

Each plain-text matrix Pᵢ is encrypted into cipher-text Cᵢ in the following way:

C₁=K(P₁+V₀)K+V₀ (1)

C₂=K(P₂+C₁)K²+P₁ . . . Cᵢ=K(Pᵢ+Cᵢ₋₁)Kⁱ+Pᵢ₋₁ (2)

In FIG. 2, the step s101 is the process for judging i>1 or not, and if i=1, then executes steps S102 and S103, and if i>1, then executes steps S104 and S105. The process in steps S102 and S103 corresponds the above described calculation (1), and the process in steps S104 and S105 corresponds the above described calculation (2).

Each corresponding cipher-text matrix Cᵢ is decrypted into plaintext Pᵢ in the following way:

P₁=K⁻¹(C₁+V₀)K⁻¹+V₀ (3)

P₂=K⁻¹(C₂+P₁)K⁻²+C₁ . . . Pᵢ=K⁻¹(Cᵢ+Pᵢ₋₁)K⁻¹+Cᵢ₋₁ (4)

FEA-M assumes employment of a master secret key in form of an n×n binary matrix K₀ which has been distributed to the parties in a secure way. Initially, the sender is required to generate session key in form of a binary matrix K. A method for the generation of the matrix K and its inverse K⁻¹ is proposed in “X. Yi, C. H. Tan, C. K. Siew and M. R. Syed, “Fast encryption for multimedia”, IEEE Transactions on Consumer Electronics, vol. 47, pp. 101-107, February 2001” and will not be discussed here because it is not relevant for our analysis.

Besides the session key matrix, the sender is required to randomly generate an initial binary matrix V₀. Each element of V₀ is randomly chosen from GF(2) so that the distribution of 0 and 1 in V₀ obeys the uniform distribution. By using the master key matrix K₀, the inverse of the session key matrix K and the initial matrix V₀ can be distributed from the sender to the receiver in the following way.

The sender side computes the following

K_{*}=K₀K⁻¹K₀ (5)

V_{*}=K₀V₀K₀ (6)

and sends (K_{*}, V_{*}) to the receiver.

The receiver side recovers K⁻¹ and V₀ by computing

K⁻¹=K₀⁻¹K_{*}K₀⁻¹, (7)

V₀=K₀⁻¹V_{*}K₀⁻¹. (8)

(3) An Upper Bound on the Effective Secret Key Size

This section yields a security evaluation of FEA-M via an analysis of the effective master secret key size. We consider FEA-M assuming that the parameter n has an arbitrary value.

Let {P^{(j)}}ⱼ₌₁^{m} denotes a set of m plain messages and {C^{(j)}}ⱼ₌₁^{m} denotes a set of the corresponding enciphered messages generated by FEA-M, where each P^{(j)} and C^{(j)} consist of r binary blocks P₁^{(j)}, P₂^{(j)}, . . . , Pᵣ^{(j)} and C₁^{(j)}, C₂^{(j)}, . . . , Cᵣ^{(j)}, respectively. Let FEA-M operates over n×n binary matrix, and the master key K₀ is an n×n binary matrix. Finally, let K_{*}^{(j)} and V_{*}^{(j)} denote the session key matrix and the initial matrix, respectively, corresponding to the jth message, j=1, 2, . . . , 4n.

In this section we analyze the effective secret key size of FEA-M, i.e. real uncertainty of the master secret key assuming that the following assumption holds.

Assumption 1.

A collection of the ciphertext blocks C₁^{(j)} is known which corresponds to different pairs (K_{*}^{(j)}, V_{*}^{(j)}) when P₁^{(j)} is the all zero matrix and K_{*}^{(j)} is an invertible matrix, j=1, 2, . . . , 4n.

Lemma 1.

Assumption 1 implies existence of the following system of equations

K₀((K_{*}^{(j)})⁻¹V_{*}^{(j)}(K_{*}^{(j)})⁻¹)K₀=C₁^{(j)}+K₀⁻¹V_{*}^{(j)}K₀⁻¹, (9)

for j=1, 2, . . . , 4n, where only K₀ is an unknown variable.

Proof.

For each j=1, 2, . . . , 4n, equation (3) implies the following one

V₀^{(j)}=(K^{(j)})⁻¹(C₁^{(j)}+V₀^{(j)})(K^{(j)})⁻¹ (10)

where

(K^{(j)})⁻¹=K₀⁻¹K_{*}^{(j)}K₀⁻¹;, (11)

V₀^{(j)}=K₀⁻¹V_{*}^{(j)}K₀⁻¹;. (12)

After some straightforward algebra, (10)-(12) imply the lemma statement.

Theorem 1.

Complexity of recovering FEA-M master secret key is proportional to n 2²ⁿ providing that Assumption 1 holds.

Sketch of the proof.

Recovering of the master secret key is equivalent to solving the system of equations given by Lemma 1 where unknown variables are elements of the master secret key matrix K₀. Underlying ideas for efficient solving this system of equations include employment of the following:

divide and conquer method,

exhaustive search over a set of hypothesis, and

solving a system of linear equations.

Note that a nonlinear system of equations over GF(2)

$${⊕}_{1 \leq k \leq n} {x}_{i , k} \cdot {y}_{kj} = {c}_{ij} , \\ i = 1 , 2 … , n \\ j = 1 , 2 , … n \qquad ( 13 )$$

where {xᵢⱼ} and {yᵢⱼ} are unknown variables reduces to a Iinear one when the set of all x-variables or y-variables is assumed.

Accordingly, if we assume values of elements in ith rows, i=1, 2, . . . , n, of K₀ and K₀⁻¹ than (9) implies that for each k=1, 2, . . . , n, we can construct a system of 4n linear equations where the unknown variables are elements in kth columns of K₀ and K₀⁻¹ and solve it in the following manner:

2n of these equations should be employed for recovering the considered kth columns under assumption that the hypothesis about the ith rows are correct, and

the remained 2n equations should be employed for checking correctness of the hypothesis.

So, it can be directly shown that above procedure implies that complexity of solving the system of equations (9) is proportional to n2²ⁿ which yields the theorem statement. Theorem 1 directly implies the following corollary.

Corollary 1.

FEA-M has effective secret key size upper bounded to 2n+log₂ n and it is n²/(2n+log₂ n) times smaller than its nominal size.

(4) An algorithm for FEA-M crypt-analysis

This section gives an algorithm for FEA-M cryptanalysis.

An algorithm for FEA-M cryptanalysis is as follows.

Input

A collection of the ciphertext blocks C₁^{(j)} which corresponds to different pairs (K_{*}^{(j)}, V_{*}^{(j)}) when P₁^{(j)} is the all zero matrix and K_{*}^{(j)} is an invertible matrix, j=1, 2, . . , 4n−2, assuming that the system of equations has the unique solution.

Processing

1. Set the first row elements of K₀ and K₀⁻¹ to a previously unconsidered pattern from the set of all 2²ⁿ possible binary patterns

2.Employing

$$\begin{matrix}{K}_{0} = X = {[ {x}_{ik} ]}_{i = 1}^{n} {,}_{k = 1}^{n} , \\ {K}_{0}^{- 1} = Y = {[ {y}_{ik} ]}_{i = 1}^{n} {,}_{k = 1}^{n} , \\ {A}^{( j )} = {{[ {a}_{ik}^{( j )} ]}_{}}_{i = 1}^{n} {,}_{k = 1}^{n} = {( {K}_{*}^{( j )} )}^{- 1} {{V}_{*}^{( j )} ( {K}_{*}^{( j )} )}^{- 1} , \\ {B}^{( j )} = {{[ {b}_{ik}^{( j )} ]}_{}}_{i = 1}^{n} {,}_{k = 1}^{n} = {V}_{*}^{( j )} , \\ {C}^{( j )} = {{[ {c}_{ik}^{( j )} ]}_{}}_{i = 1}^{n} {,}_{k = 1}^{n} = {C}_{1}^{( j )} ,\end{matrix}$$

construct the following system of 4n−2 linear equations with 2n−2 unknown binary variables:

$$\begin{matrix}{{⊕}_{m = 1}}^{n} {α}_{1 m}^{( j )} {x}_{mk} = {c}_{1 k}^{( j )} ⊕ ( {{⊕}_{m = 1}}^{n} {β}_{1 m}^{( j )} {y}_{mk} ) , j = 1 , 2 , … , 4 n - 2 \\ where & ( 14 ) \\ \begin{matrix}{α}_{1 m}^{( j )} = {{⊕}_{l = 1}}^{n} {x}_{1 l} {a}_{lm}^{( j )} , \\ {β}_{1 m}^{( j )} = {{⊕}_{l = 1}}^{n} {y}_{1 l} {b}_{lm}^{( j )} ,\end{matrix} & ( 15 )\end{matrix}$$

are known under the considered hypothesis about [x₁ₖ]ⁿₖ₌₁ and [y₁ₖ]ⁿₖ₌₁.

3. Do the following

(a) Recover [xᵢ₁]ⁿᵢ₌₂ and [yᵢ₁]ⁿᵢ₌₂ solving the corresponding system of the first 2n−2 linear equations under the given hypothesis.

(b) Employ the remained 2n equations for checking correctness of the hypothesis by checking consistence of these equations with the current hypothesis and the obtained solution, by evaluating (14) for j=2n−1, 2n, . . . , 4n−2; consequently perform the following actions:

i. if all the checks are positive accept the candidates as the true ones and memorize them as the first rows and columns of K₀ and K₀⁻¹.

ii. otherwise go to Step 1.

4. For each k=2, 3, . . . , n do the following:

recover [xᵢₖ]ⁿᵢ₌₂ and [yᵢₖ]ⁿᵢ₌₂ solving the system of equations (14) when j=1, 2, . . . , 2n−2, using [x₁ₖ]ⁿᵢ₌₁ and [y₁ₖ]ⁿᵢ₌₁ recovered in Step 3(b);

memorize the solution [xᵢₖ]ⁿᵢ₌₁ and [yᵢₖ]ⁿᵢ₌₁ as the kth columns of K₀ and K⁻¹₀;

if k=n go to Output.

Output

Recovered master secret key K₀.

(5) Consequences of the Effective Secret Key Size

In the previous section the effective size of FEA-M master secret key has been derived, and this section points out the security consequences of the derived result. The discussion is not limited only to the case when n=64 suggested in in “X. Yi, C. H. Tan, C. K. Siew and M. R. Syed, “Fast encryption for multimedia”, IEEE Transactions on Consumer Electronics, vol. 47, pp. 101-107, February 2001” because FEA-M can operate for any n and it is reasonable to assume that an interested party might employ FEA-M using a smaller value of the parameter n in order to use smaller secret key size which is equal to n².

Regarding the security of FEA-M, the above reference takes into account the following statement: For multimedia applications, information rate is very high, but the information value is very low, and so, breaking the encryption code is much more expensive than to buy the legal access.

Although the previous statement is a correct one for a large number of situations, it is still interesting and important to know as precise as possible the security margins of any enciphering scheme.

Scenario for deriving the effective master secret key size which assumes that in a number of the data streams the first n×n block consists of all zeros is at least a possible one and should be taken into account for the overall security evaluation.

Accordingly, Corollary 1 is numerically considered by the Table I shown in FIG. 3.

Table I is an illustration for the following statements:

(i) The nominal secret key size yields a misleading information regarding the security of FEA-M because real uncertainty of the master secret key is totally different in a scenario given by Assumption 1.

(ii) In the case proposed in the above mentioned reference, when the parameter n=64 FEA-M is not breakable by the approach given in Section (4) because it requires an exhaustive search over 2^{1 3 4} hypothesis, but the uncertainty on master secret key is smaller than it is indicated by the master secret key length for a factor proportional to 2^{3 9 6 2}. Accordingly, this implies a very inefficient use of the employed master secret key which is an undesirable property.

(iii) The NESSIE project disclosed in “New European Schemes for Signatures, Integrity and Encryption (NESSIE) Project”, for example, implies that a 256-bits secret key is a very large one, and on the other hand FEA-M with the same key size is a totally insecure encryption algorithm because in this case the effective secret key size is only 36 bits.

(iv) Moreover, FEA-M can be considered as an insecure enciphering technique if the employed master secret key is smaller than 1024 bits.

(6) Sensitivity on Packet Loss Errors

We focus on a probabilistic model of packet loss within the network. Accordingly, in this section we consider FEA-M scheme in a (q, 1)-network. In such a network, each packet can be lost independently at random with probability q. Note that “V. Paxson, “End-to-end Internet packet dynamics”, IEEE/ACM Transactions on Networking, vol. 7, pp. 277-292, 1999” presents an experimental study which includes consideration of the packets loss on the Internet. The current Internet does not provide any loss guarantee, and in particular the packet loss ratio could be very high.

Property 1.

Suppose that an r-blocks length message is encrypted by FEA-M. Than, if a block j, j<r, is the first lost block of the message ciphertext, only a part of the message consisting of the first j−1 blocks can be decrypted.

Proof.

Recall that decryption of the jth block and further blocks is given by the following:

Pᵢ=K⁻¹(Cᵢ+Pᵢ₋₁)K⁻¹+Cᵢ₋₁, (16)

i=j, j+1, . . . , r.

Accordingly, it is directly evident that if the ciphetext block Cⱼ is lost, no one block P₁, i≧j can be decrypted.

Corollary 2.

When the number of message blocks r is grater than q⁻¹, expected number of completely decrypted messages is close to 0.

Previous statements show that FEA-M is not suitable for applications in a network where the packets can be lost because when a packet is lost, all the packets after that one can not be decrypted, and accordingly the corresponding part of the message can not be used.

(7) Boolean Matrix Based Encryption Algorithm

We assume that a message is divided into a series of blocks P₁, P₂, . . . , Pᵣ with same length n². If the length of the last block is less than n², we need append some 0s in it so that it length is right n². The n² bits of each block are arranged as a square matrix of order n.

The encryption and decryption processes involve the session key K and the initial matrix V which are binary matrices of order n. In the proposed scheme we assume employment of the same key distribution as it is reported in the reference article “X. Yi, C. H. Tan, C. K. Siew and M. R. Syed, “Fast encryption for multimedia”, IEEE Transactions on Consumer Electronics, vol. 47, pp. 101-107, February 2001”.

Accordingly, we assume existence of a master secret key in form of an n×n binary matrix K_{M} which has been distributed to the parties in a secure way. Initially, the sender is required to generate session key in form of a binary matrix K. A method for the generation of the matrix K and its inverse K⁻¹ is given in the above-mentioned reference. Besides the session key matrix, the sender is required to randomly generate an initial binary matrix V.

Each element of V is randomly chosen from GF(2) so that the distribution of 0 and 1 in V obeys the uniform distribution. By using the master key matrix K_{M}, the inverse of the session key matrix K and the initial matrix V can be distributed from the sender to the receiver in the following way.

The sender side computes the following

K^{(e)}=K_{M}K⁻¹K_{M} (17)

V^{(e)}=K_{M}VK_{M} (18)

and sends (K^{(e)}, V^{(e)}) to the receiver.

The receiver side recovers K⁻¹ and V by computing

K⁻¹=K_{M}⁻¹K^{(e)}K_{M}⁻¹ (19),

V=K_{M}⁻¹V^{(e)}K_{M}⁻¹ (20),

In here proposed algorithm, each plaintext matrix Pᵢ is encrypted into ciphertext Cᵢ, and each corresponding ciphertext matrix Cᵢ is decrypted into plaintext Pᵢ in the following way.

Cᵢ=K(Pᵢ+K*ᵢVT)Kᵢ (21)

Pᵢ=K⁻¹CᵢK*ᵢ+K*ᵢVT (22)

The following figures and algorithms specify the encryption and decryption sequences in accordance with this invention.

The encryption sequence is shown in FIG. 4, and the decryption sequence is shown in FIG. 5. FPGA configuration is suitable for processing these encryption and decrption algorithms, because each configurable logic block (CLB) in FPGA can process the each process block in FIG. 4 and FIG. 5.

Encryption Algorithm (FIG. 4) is as follows.

(1) Input:

secret: master secret key K_{M}, message secret key K, and message seed V;

public: plaintext {Pᵢ}ᵢ₌₁^{m}.

(2) Preprocessing:

calculate: Kⁿ and K⁻ⁿ=(K⁻¹)ⁿ;

set: K₀=Kⁿ and K₀*=K⁻ⁿ.

(3) Processing: (Step S211, S221)

for each i=1, 2, . . . , m, do the following:

(3-1) calculate: T=[tᵣₛ]=KKᵢ₋₁.

(3-2) calculate:

$$y = {⊕}_{r = 1}^{n} {t}_{rr}$$

and based on the judgment whether y=0 or 1 (Step, S212, S222), do the following:

(a) if y=1→Kᵢ=T (Step, S214)

(b) if y=0→KᵢKT (Step, S213)

(c) if y=1→K*ᵢK⁻¹K*ᵢ₋₁ (Step, S224)

(d) if y=0→K*ᵢ=K⁻¹K⁻¹K*ᵢ₋₁ (Step, S223)

In the step S215, and S225, depending on the value of y, that is whether y=0 or 1, the output can be selected, and then executes the following calculation step.

(3-3) calculate: (Step S231)

Cᵢ=K(Pᵢ+K*ᵢVT)Kᵢ

(4) Output:

Cᵢ=, i=1, 2, . . . , m.

As described above, the encryption sequence is executed, and the ciphertext Cᵢ can be generated.

Decryption Algorithm is as follows. (Please refer to FIG. 5)

(1) Input:

secret: master secret key K_{M};

public: plaintext {Pᵢ}^{m}ᵢ₌₁, encrypted forms of session secret key and session seed, K^{(e)} and V^{(e)}, respectively.

(2)Preprocessing:

recover session secret key K and session seed V by the following:

K⁻¹=K_{M}⁻¹K^{(e)}K_{M}⁻¹;

V=K_{M}⁻¹V^{(e)}K_{M}⁻¹.

calculate: Kⁿ and K⁻ⁿ=(K⁻¹)ⁿ;

set: K₀=Kⁿ and K₀*=K⁻ⁿ.

(3) Processing: (Step S311, S321)

for each i=1, 2, . . . , m, do the following:

(3-1) calculate: T=[tᵣₛ]KKᵢ₋₁.

(3-2) calculate:

$$y = {⊕}_{r = 1}^{n} {t}_{rr}$$

and based on the judgment whether y=0 or 1 (Step, S312, S322), do the following:

(a) if y=1→Kᵢ=T (Step, S314)

(b) if y=0→Kᵢ=KT (Step, S313)

(c) if y=1→K*ᵢ=K⁻¹K*ᵢ₋₁ (Step, S324)

(d) if y=0→K*ᵢ=K⁻¹K⁻¹K*ᵢ₋₁ (Step, S323)

In the step S215, and S225, depending on the value of y, that is whether y=0 or 1, the output can be selected, and then executes the following calculation step.

(3-3) calculate: (Step S331)

Pᵢ=K⁻¹CᵢK*ᵢ+K*ᵢVT

(4) Output:

Pᵢ=, i=1, 2, . . . , m.

As described above, the decryption sequence is executed, and the plaintext Pᵢ can be generated.

(8) Encryption in SDR System

An illustration of employment of the proposed encryption for the privacy protection of the software to be downloaded into SDR is displayed in FIG. 6.

The software program with digital signature 201 is encrypted by encryption function 202 with a secret key 203 which is valid only for a single terminal. This encryption function 202 is configured in FPGA in a tamper resistant ROM. This encryption function 202 executes the encryption algorithm described above (shown in FIG. 4).

This encryption function 202 process creates signed and encrypted program 204. That is, only that terminal has the knowledge of the secret key 203. The secret key 203 is stored in tamper proof hardware on the terminal device. Since symmetric encryption techniques are used, the encryption and decryption is much faster then asymmetric techniques. This is an advantage for real-time encryption and also for speedy loading of the bitfile into the FPGA.

(9) Decryption at the Terminal in SDR System

The functionality diagram of the terminal hardware is shown in FIG. 7.

The decryption of the downloaded software is essentially the reverse of the encryption process.

First the encrypted bitfile 451 is decrypted using the terminal secret key 452 (S401). In this decryption process, the above explained decryption algorithm (shown in FIG. 5) is executed.

Next, the digital signature (which is an encrypted hash function) is decrypted using the government public key 453, available to all terminals (S402). Using the known hash function the decrypted bitfile hash or fingerprint is calculated (S403), and if the two match (S404) then the software is legitimate and has not been modified since it was approved (S405).

Therefore, based on this verification of integrity and authentication, the bitfile should be downloaded into the FPGA. If the fingerprints do not match, then the software has been modified or is not signed and approved by the government, and is not loaded and the appropriate error messages should be displayed to the user.

The security check described above is executed by a security check device which is configured in FPGA in a tamper resistant hardware package. This tamper resistant hardware package also comprises a re-configurable logic (FPGA) for downloading the decrypted bitfile.

Terminal secret key 452 and government public key 453 are stored in a memory in the security check device equipped in the tamper resistant hardware package. In one example, a manufacturer of wireless data communication apparatus, such as SDR, stores these key in tamper resistant hardware package.

(10) SDR Configuration

FIG. 8 shows a block diagram of a wireless data communication apparatus, for example SDR, in accordance with a preferred embodiment of the present invention. SDR comprises transceiver 501, A/D,D/A converter 502, tamperproof (tamper resistant) hardware package which includes reconfigurable logic and a device for processing security function, digital signal processor (DSP) 504, CPU 505, ROM 506, Memory 507, I/O interface 508 and A/D.D/A converter 509. Data can be transmitted between above mentioned elements through a data bus.

A software program (bitstream) to be downloaded to the reconfigurable logic in tamperproof hardware package 503 is received by transceiver 501, and transmitted to tamperproof hardware package 503. Security check process for the transmitted program is executed by a security check device which is also configured by FPGA in tamperproof hardware package 503. The security check device verifies whether a program is proper, and only the verified program is permitted to be downloaded to the reconfigurable logic.

The security check device equipped in the tamper resistant hardware package comprises a processing unit for executing security check process as to a software program to be downloaded to the reconfigurable logic in the same tamper resistant hardware package.

The security check device further comprises memory storing a secret key. A processing unit in a security check device executes decryption of an encrypted software program by using said secret key. In one example, this secret key is uniquely assigned to each wireless data communication apparatus.

The security check device further comprises memory storing an authorized agency's public key. The security check device checks digital signature attached to a software program by using the authorized agency's public key.

The security check device equipped in a tamper resistant hardware package executes authentication procedure by checking a digital signature attached to a software program, and executes verification of integrity of the software program by calculating hash value based on software program data.

(11) System Configuration

FIG. 9 shows a block diagram for a wireless network in which the present invention's algorithm can be applied. Software defined radio (SDR) terminals 621, 623, 624 . . . may receive, transmit, or both using either simplex or duplex communication techniques. Reconfigurable logic (Programmable logic device (PLD)) is equipped in SDR. One type of PLD, a field programmable gate array (FPGA), typically includes elements such as configurable logic blocks (CLBs), input/output blocks (IOBs), and interconnect that programmably connects the CLBs and IOBs.

The configuration of the CLBs, IOBs, and interconnect is determined by a bit-stream. Reconfigurable logic is equipped in tamperproof hardware package 650. This tamperproof hardware package 650 also includes another reconfigurable logic for processing security functions, such as authentication, verification of integrity of the software to be download to the other reconfigurable logic.

The bit-stream for downloading is sent from Server 601 through base station 611. Further software program (bitstream) can be loaded from storage devices such as optical memory devices, magneto memory devices, and so on.

FIG. 10 shows a data communication system comprising a server device 710 and a client device 720. The server device 710 sends data encrypted by the above explained encryption algorithm, and the client device 720 received the date and decrypts the received data utilizing the above explained decryption algorithm.

The data is transmitted through public communication channel (e.g. internet) 750.

The server device 710 comprises a data enciphering means 712 which executes a process of dividing a data message 711 into a series of blocks P₁, P₂, . . . , Pₙ, and executes a process of generating a series of encrypted data message blocks C₁, C₂, . . . , Cₙ by computing the above explained equation,

Cᵢ=K(Pᵢ+K*ᵢVT)Kᵢ

In this encryption process, Secret key K 713 is used. Secret key K 713 is a session key in form of an n×n binary matrix.

The client device 720 receives encrypted data 721. The client device 720 comprises a data deciphering means 722 which executes a process of generating a series of plain data message blocks P₁, P₂, . . . , Pₙ 724 by computing the above explained equation,

Pᵢ=K⁻¹CᵢK*ᵢ+K*ᵢVT

In this decryption process, Secret key K 723 is used. Secret key K 723 is a session key in form of an n×n binary matrix.

(12) Conclusion

Although the invention has been described with reference to specific embodiments, this description is not meant to be construed in a limiting sense. Various modifications of the disclosed embodiment, as well as alternative embodiments of the invention, will become apparent to persons skilled in the art upon reference to the description of the invention. It is therefore contemplated that such modifications can be made without departing from the spirit or scope of the present invention as defined in the appended claims.

According to the present invention, starting from an analysis and comparison of the main security issues related to SDR and an usual internet downloading, and identified specific characteristics, a novel dedicated cipher for SDR secure downloading based on Boolean Matrices can be provided.

The encryption algorithm according to this invention does not follow the standard paradigm of a block or stream cipher, it employs a very long secret key, and it is resistant against all known attacks. On the other hand, the developed encryption technique offers low implementation complexity, and suitability for FPGA and DSP frameworks of SDR.

According to the present invention, a Boolean matrices based encryption and decryption method can be provided, which is resistant against recently developed secret key recovering procedure.

### BRIEF DESCRIPTION OF DRAWINGS

FIG. 1. Table of security comparison data between SDR download and usual Internet download.

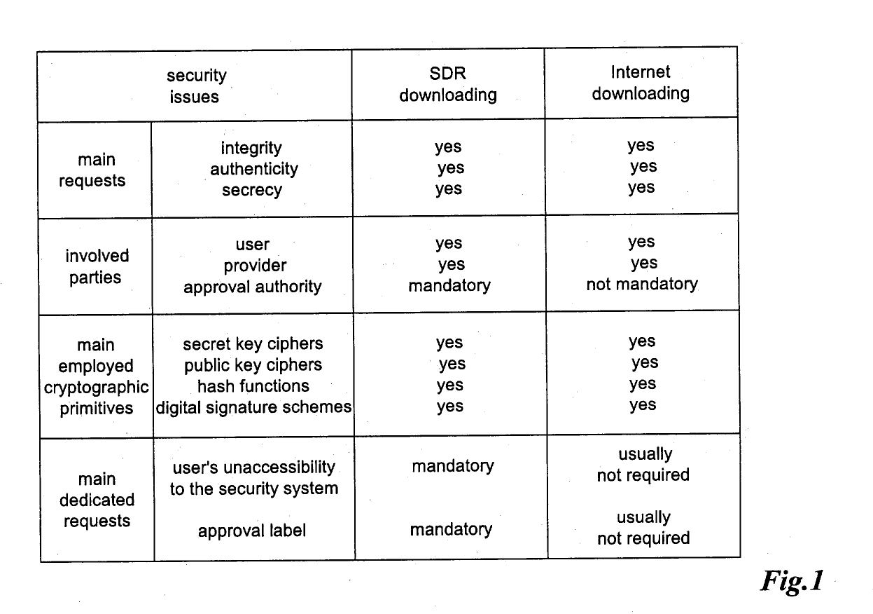

FIG. 2. Flow-chart of FEA-M encryption algorithm.

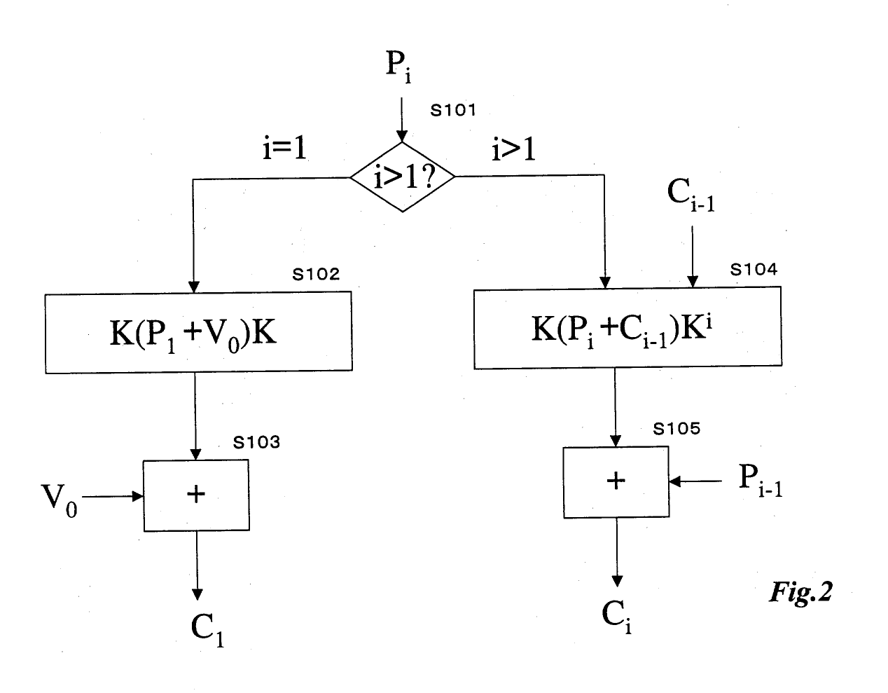

FIG. 3. Table of nominal and effective master secret key size.

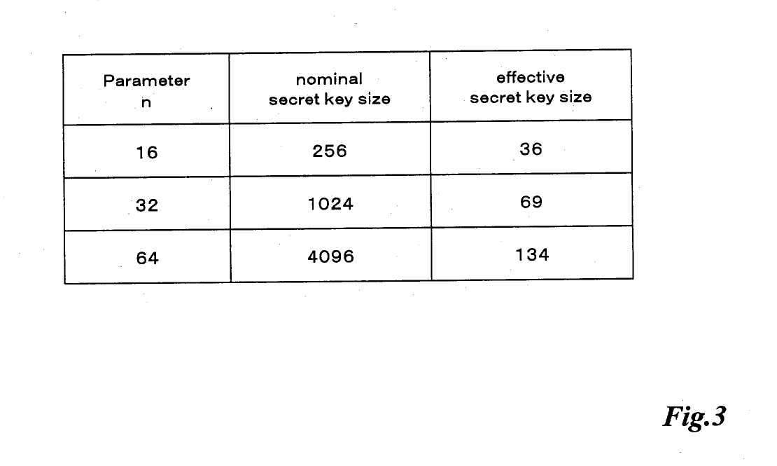

FIG. 4. Flow-chart of the improved encryption algorithm in accordance with this invention.

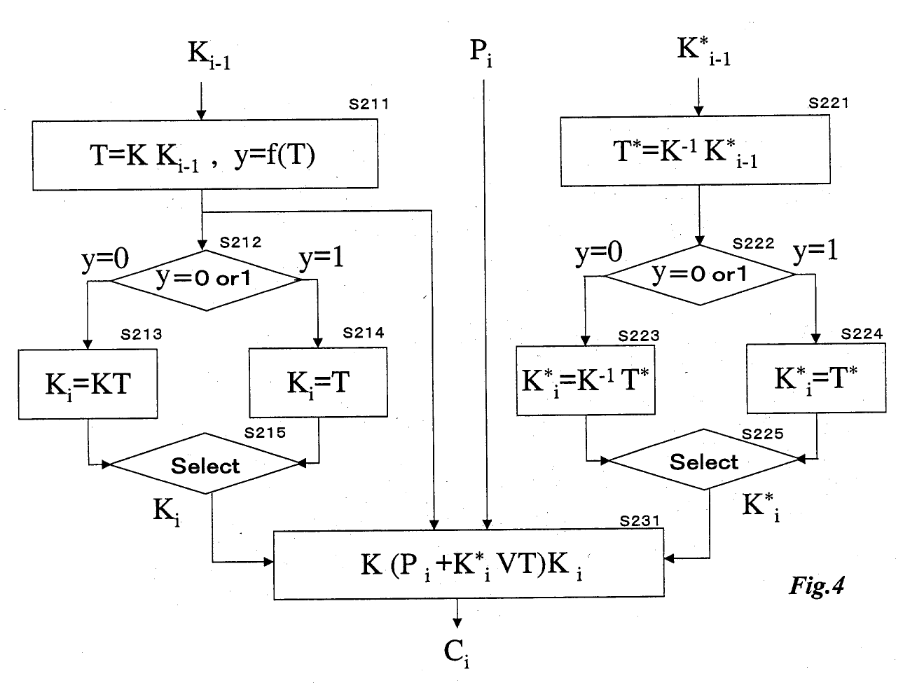

FIG. 5. Flow-chart of the improved decryption algorithm in accordance with this invention.

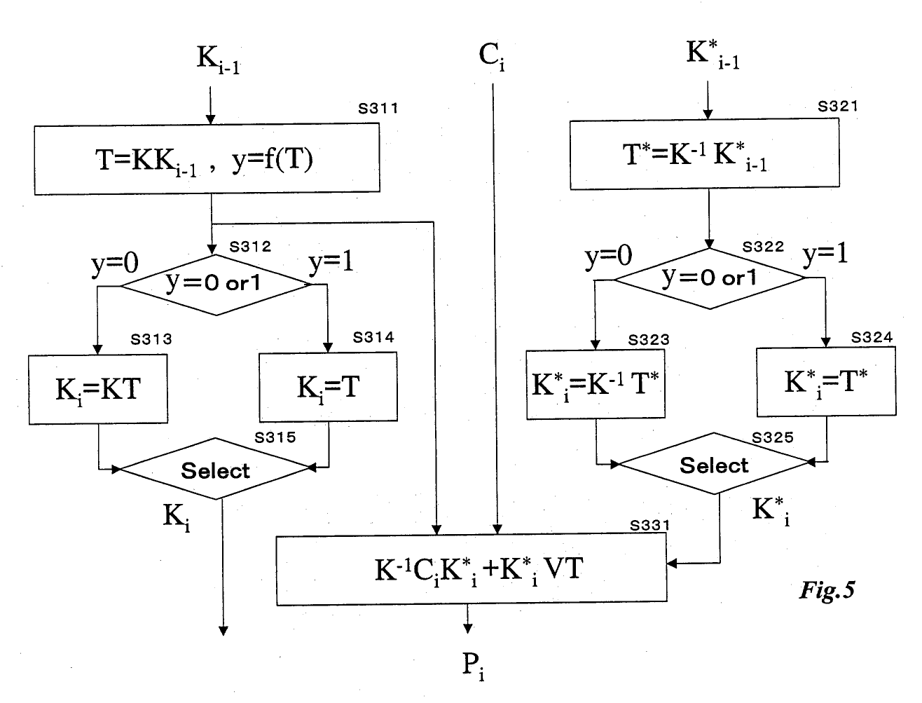

FIG. 6. Block diagram of the configuration for processing data encryption in SDR.

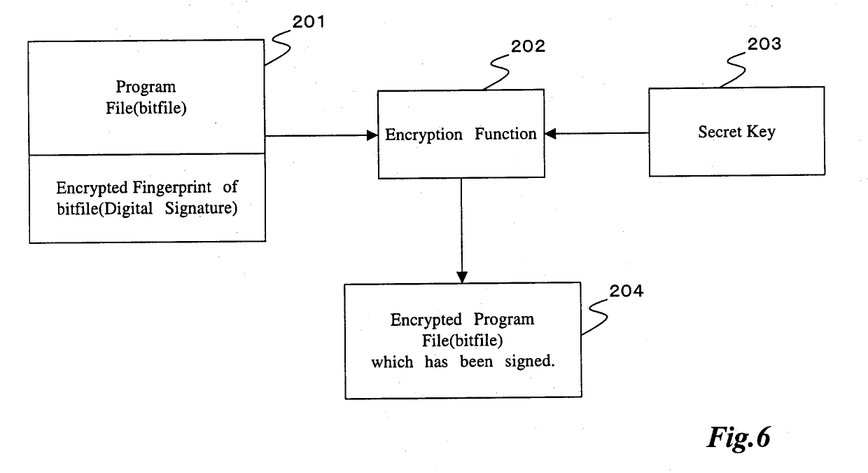

FIG. 7. Functionality diagram of security check device in the terminal (SDR).

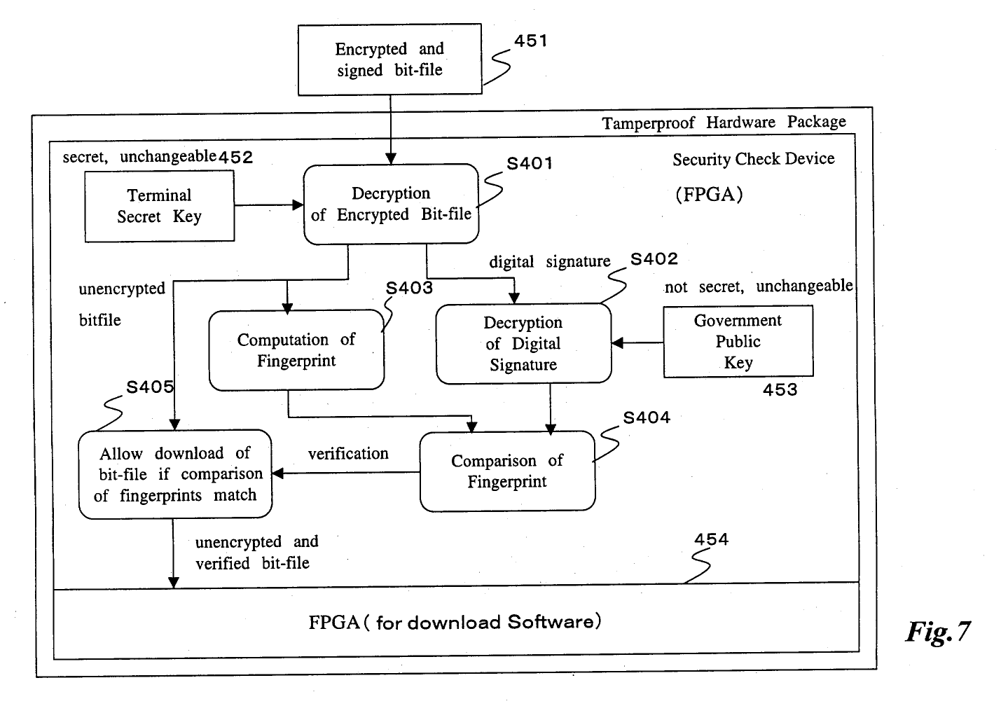

FIG. 8 Block diagram of a wireless data communication apparatus (SDR).

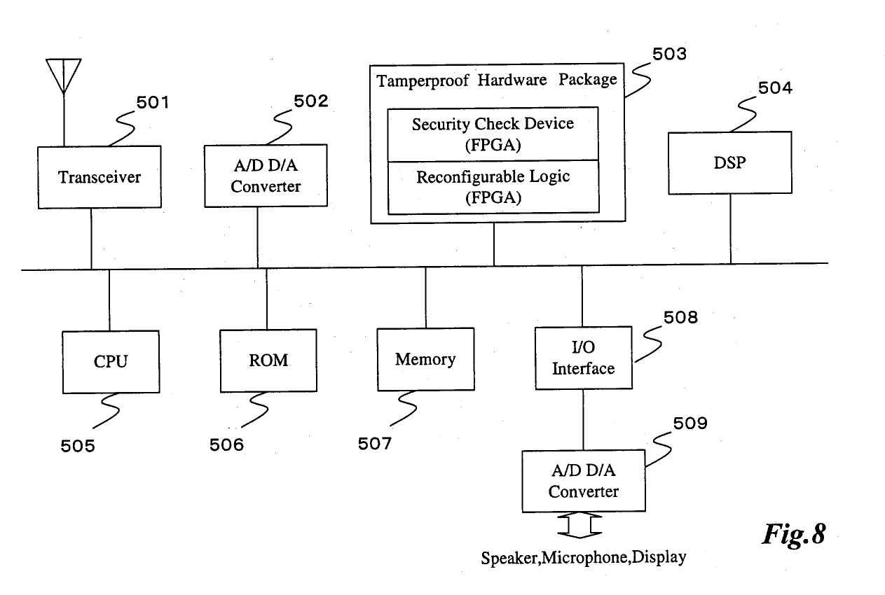

FIG. 9 Block diagram for a wireless network in which the present invention's algorithm can be applied.

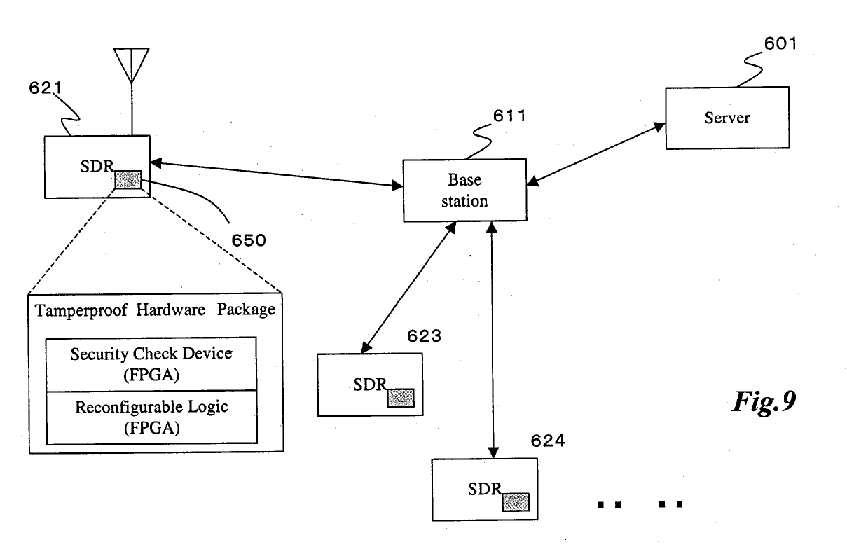

FIG. 10 Block diagram for security check devices in server and client system which utilizes the improved FEA-M encryption and decryption algorithm.

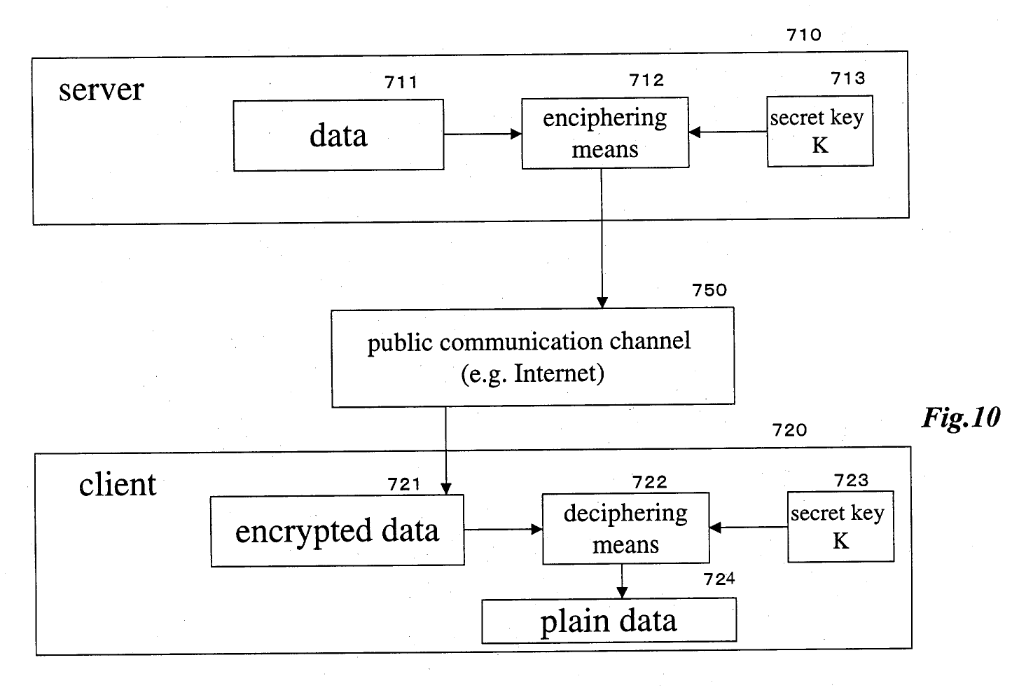

### DESCRIPTION OF THE REFERENCE NUMBER

201 Software program

202 Encryption function

203 Secret key

204 Encrypted program file

451 Encrypted and signed bitfile

452 Terminal Secret Key

453 Government Public Key

501 Transceiver

502 A/D,D/A Converter

503 Tamperproof Hardware Package

504 DSP

505 CPU

506 ROM

507 Memory

508 I/O Interface

509 A/D,D/A converter

601 Server

611 Base Station

621, 623, 624, SDR

650 Tamperproof Hardware Package

710 Server device

711 data

712 enciphering means

713 secret key K

720 client device

721 encrypted data

722 deciphering means

723 secret key

724 plain data

750 public communication channel

1. A method for encrypting a data message, comprising the steps of:
(A) dividing a data message into a series of blocks P₁, P₂, . . . , Pₘ, wherein block number is m;
(B) calculating: Kⁿ and K⁻ⁿ=(K⁻¹)ⁿ; and, setting: K₀=Kⁿ and K₀*=K⁻ⁿ
wherein the parameters are defined as follows;
K: Session key in form of an n×n binary matrix
K⁻¹: Inverse matrix of K,
(C) for each i=1, 2, . . . , m, do the following steps,
(C-1) calculating: T=[tᵣₛ]=KKᵢ₋₁,
(C-2) calculating:
$$y = {⊕}_{r = 1}^{n} {t}_{rr}$$
(c-3) and calculating Kᵢ and K*ᵢ according to the following equations:
(a) if y=1→Kᵢ=T
(b) if y=0→Kᵢ=KT
(c) if y=1→K*ᵢ=K⁻¹K*ᵢ₋₁
(d) if y=0→K*ᵢ=K⁻¹K⁻¹K*ᵢ₋₁
(D) generating a series of encrypted data message blocks C₁, C₂, . . . , Cₘ; by computing the following equation,
Cᵢ=K(Pᵢ+K*ᵢVT)Kᵢ,
Wherin V is initial n×n binary matrix.

2. The method according to claim 1, said method further comprising the step of:
generating following values K^{(e)} and V^{(e)} which can be used at the data decryption side for recovering values: K⁻¹ and V,
K^{(e)}=K_{M}K⁻¹K_{M}
V^{(e)}=K_{M}VK_{M}.

3. A method for decrypting an encrypted data message, comprising the steps of:
(A) inputting a series of encrypted data message blocks C₁, C₂, . . . , Cₘ, wherein block number is m;
(B) calculating: Kⁿ and K⁻ⁿ=(K⁻¹)ⁿ; and, setting: K₀=Kⁿ and K₀*=K⁻ⁿ,
wherein the parameters are defined as follows;
K: Session key in form of an n×n binary matrix
K⁻¹: Inverse matrix of K
(C) for each i=1, 2, . . . , m, do the following steps,
(C-1) calculating: T=[tᵣₛ]=KKᵢ₋₁,
(C-2) calculating:
$$y = {⊕}_{r = 1}^{n} {t}_{rr}$$
(C-3)and calculating Kᵢ and K*ᵢ according to the following equations:
(a) if y=1→Kᵢ=T
(b) if y=0→Kᵢ=KT
(c) if y=1→K*ᵢ32 K⁻¹K*ᵢ₋₁
(d) if y=0→K*ᵢ=K⁻¹K⁻¹K*ᵢ₋₁
(D)generating a series of plain data message blocks P₁, P₂, . . . , Pₘ; by computing the following equation,
Pᵢ=K⁻¹CᵢK*ᵢ+K*ᵢVT,
Wherin V is initial n×n binary matrix.

4. The method according to claim 3, said method further comprising the step of:
generating following values K⁻¹ and V by computing the following equation,
K⁻¹=K_{M}⁻¹K^{(e)}K_{M}⁻¹;
V=K_{M}⁻¹V^{(e)}K_{M}⁻¹.
wherein K_{M} is a master secret key in form of n×n binary matrix, and as to K^{(e)} and V^{(e)}, following equations are defined,
K^{(e)}=K_{M}K⁻¹K_{M}
V^{(e)}=K_{M}VK_{M}.

5. A data processing device for encrypting a data message, comprising:
(A) a data processing logic for dividing a data message into a series of blocks P₁, P₂, . . . , Pₘ, wherein block number is m;
(B) a data computing logic for calculating Kⁿ and K⁻ⁿ=(K⁻¹)ⁿ; and setting: K₀=Kⁿ and K₀*=K⁻ⁿ
wherein the parameters are defined as follows;
K: Session key in form of an n×n binary matrix
K⁻¹: Inverse matrix of K,
(C) a data computing logic for processing the following calculation (c-1) to (c-3) for each i=1, 2, . . . , m, do,
(C-1) calculation: T=[tᵣₛ]=KKᵢ₋₁,
(C-2) calculation:
$$y = {⊕}_{r = 1}^{n} {t}_{rr}$$
and (c-3) calculation:
(a) if y=1→Kᵢ=T
(b) if y=0→Kᵢ=KT
(c) if y=1→K*ᵢ=K⁻¹K*ᵢ₋₁
(d) if y=0→K*ᵢ=K⁻¹K⁻¹K*ᵢ₋₁
(D) a data computing logic for generating a series of encrypted data message blocks C₁, C₂, . . . , Cₘ; by computing the following equation,
Cᵢ=K(Pᵢ+K*ᵢVT)Kᵢ,
Wherin V is initial n×n binary matrix.

6. The data processing device according to claim 5, said data processing device further comprises:
a data computing logic for generating following values K^{(e)} and V^{(e)} which are used at the data decryption side for recovering values: K⁻¹ and V,
K^{(e)}=K_{M}K⁻¹K_{M}
V^{(e)}=K_{M}VK_{M}.

7. The data processing device according to claim 5,
wherein the data processing device is configured in a field programmable gate array.

8. An data processing device for decrypting an encrypted data message, comprising:
(A) a data input means for inputting a series of encrypted data message blocks C₁, C₂, . . . , Cₘ, wherein block number is m;
(B) a data computing logic for calculating Kⁿ and K⁻ⁿ=(K⁻¹)ⁿ; and, setting: K₀=Kⁿ and K₀*=K⁻ⁿ,
wherein the parameters are defined as follows;
K: Session key in form of an n×n binary matrix
K⁻¹: Inverse matrix of K
(C) a data computing logic for processing the following calculation (c-1) to (c-3) for each i=1, 2, . . . , m, do,
(C-1) calculation: T=[tᵣₛ]=KKᵢ₋₁,
(C-2) calculation:
$$y = {⊕}_{r = 1}^{n} {t}_{rr}$$
and (c-3) calculation:.
(a) if y=1→Kᵢ=T
(b) if y=0→Kᵢ=KT
(c) if y=1→K*ᵢ=K⁻¹K*ᵢ₋₁
(d) if y=0→K*ᵢ=K⁻¹K⁻¹K*ᵢ₋₁
(D) a data computing logic for generating a series of plain data message blocks P₁, P₂, . . . , Pₘ; by computing the following equation,
Pᵢ=K⁻¹CᵢK*ᵢ+K*ᵢVT,
Wherin V is initial n×n binary matrix.

9. The data processing device according to claim 8, said data processing device further comprises:
a data computing logic for generating following values K⁻¹ and V by computing the following equation,
K⁻¹=K_{M}⁻¹K^{(e)}K_{M}⁻¹;
V=K_{M}⁻¹V^{(e)}K_{M}⁻¹.
wherein K_{M} is a master secret key in form of n×n binary matrix, and as to K^{(e)} and V^{(e)} following equations are defined,
K^{(e)}=K_{M}K⁻¹K_{M}
V^{(e)}=K_{M}VK_{M}.

10. The data processing device according to claim 8,
wherein the data processing device is configured in a field programmable gate array.
